(19) United States
(12) Patent Application Publication
(10) Pub. No.: US 2026/0124979 A1
(43) Pub. Date: May 7, 2026

(54) Easily Assembled Cargo Tray

(71) Applicant: James Lachenberg, Cumming, GA (US)

(72) Inventor: James Lachenberg, Cumming, GA (US)

(21) Appl. No.: 19/370,202

(22) Filed: Oct. 27, 2025

Related U.S. Application Data
(60) Provisional application No. 63/833,222, filed on Nov. 7, 2024.

(51) Int. Cl. B60P 1/64

(52) U.S. Cl. CPC B60P 1/6409

(57) ABSTRACT

A cargo tray for a vehicle cargo bed includes a deck formed by elongated planks arranged side-by-side and interconnected along their lengths. Transverse front and rear support members are positioned at opposite deck ends. Tension members or flat bars span between the support members to draw them together and maintain the planks as a flat unit, enabling smooth sliding without rollers. The planks are hollow polymer extrusions having internal ribs and a low-friction surface. A handle assembly is mounted to the front support for pushing or pulling the cargo tray toward the front or back end of the vehicle. In some embodiments, the planks are pre-joined by an integral web so the deck can be folded into a bundle, which has the dimensions of the flattened cargo tray when unfolded and easily shipped for assembly. The rear support member can include an upright backstop flange and apertures for tethers.

### CROSS REFERENCE TO RELATED APPLICATIONS

This application claims the benefit of U.S. Provisional Application Ser. No. 63/833,222 filed Nov. 7, 2024, having the title “Easily Assembled Cargo Tray” by James A. Lachenberg, which is incorporated herein by reference in its entirety.

### BACKGROUND OF THE INVENTION

Pickup trucks are excellent for carrying large loads that do not fit easily, or at all, into most vehicles including SUVs. The large open space behind the enclosed seating area accommodates bulky and heavy loads, although getting such loads in and out of the vehicle bed can be quite a challenge. Typically, a truck owner needs to place the load into that part of the bed near the tailgate and then climb into the bed to move it forward so that more stuff can be loaded - a non-trivial task. This is then repeated in reverse when unloading the trunk bed. To deal with these concerns, many designs exist that provide a large flat platform (e.g. 4 ft×6 ft) that fits between the wheel wells of the truck and slides back and forth. In some cases, the platform includes wheels on its bottom side to facilitate sliding, while in other cases rails are installed in the trunk bed for the same purpose. While these solutions work well, they are quite expensive and cannot be easily shipped to, or assembled and installed by a pickup-truck owner and not require an automotive expert or company to install.

Accordingly, what is desired is an easily assembled cargo tray, sometimes called a truck-bed slider, for pickup trucks, SUVs or other vehicles, that can be conveniently shipped to and installed by the vehicle owner.

### SUMMARY OF THE INVENTION

A cargo tray comprises a plurality of side-by-side interconnected planks that are clamped by front and rear transverse support members. In one embodiment, wire-rope or cylindrical metal rod tension members draw the support members together to place the planks in longitudinal compression. Alternatively, tension members can be avoided by rotating the cargo tray 90 degrees and interchanging the length and width dimensions of its planks. In another embodiment, flat bars connect the front and rear support members to clamp the planks. The transverse support members align the planks into a flat surface so that the planks can function as a sliding deck. At least one handle is attached to the front end of the tray for pulling or pushing it. The handle may be rotation-limited to improve pushing leverage while reducing pinching. Illustratively the planks are made from vinyl and are hollow with vertical ribs. Vinyl reduces the weight of the planks when compared with other materials used in known cargo tray designs and slides easily on most surfaces to avoid the need for rollers. Its hollow structure allows the tension members to pass through the planks without interfering with the top or bottom surfaces of the tray, while its vertical ribs increase the structural integrity of the tray when carrying heavy loads.

### DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows the cargo tray of the present invention installed in the bed compartment of a typical pickup truck between its wheel wells. The tailgate of the pickup truck is shown pulled down with the cargo tray pulled out a bit.

FIG. 2 is a top view of the cargo tray showing a plurality of joined planks supported at its opposite ends by a pair of rigid members. The front member has a pair of attached handles to facilitate pushing or pulling the cargo tray in and out of the bed compartment.

FIG. 3 is a front perspective view of one plank showing its tongue and groove construction, hollow structure, and vertical ribs.

FIG. 4 is a front perspective view of an alternate design for a plank with interlocking tongue and groove construction.

FIG. 5 is an end view of a plurality of fully connected planks that are held together as a bundle by the same material used in making the planks.

FIG. 6 is a front-side perspective view of the front and rear support members that align the planks in the transverse direction and hold them together as a flat unit using tension members.

FIG. 7 is a front-side perspective view of the cargo tray and a Detail A showing the shape of the front support member and one of its attached handle assemblies.

FIG. 8 shows two different tension member designs that extend between the front and rear support members for pulling them towards each other in order support the planks as a unit when the cargo tray is pulled or pushed. Also shown is a metal bar that can replace the use of tension members if desired.

FIG. 9 is a front-side perspective view of the front and rear support members that hold and align the planks (not shown) as a flat unit using flat metal bars.

### DETAILED DESCRIPTION

### Important Features of the Subject Cargo Tray Include:

1) Ease of assembly;
2) Lightweight materials for shipping and moving in/out of a vehicle;
3) Planks that easily slide on the bed of a pickup truck or other vehicle;
4) Substantially hollow planks having sufficient strength to support heavy loads; and
5) Handles that rotate to improve pushing and pulling.

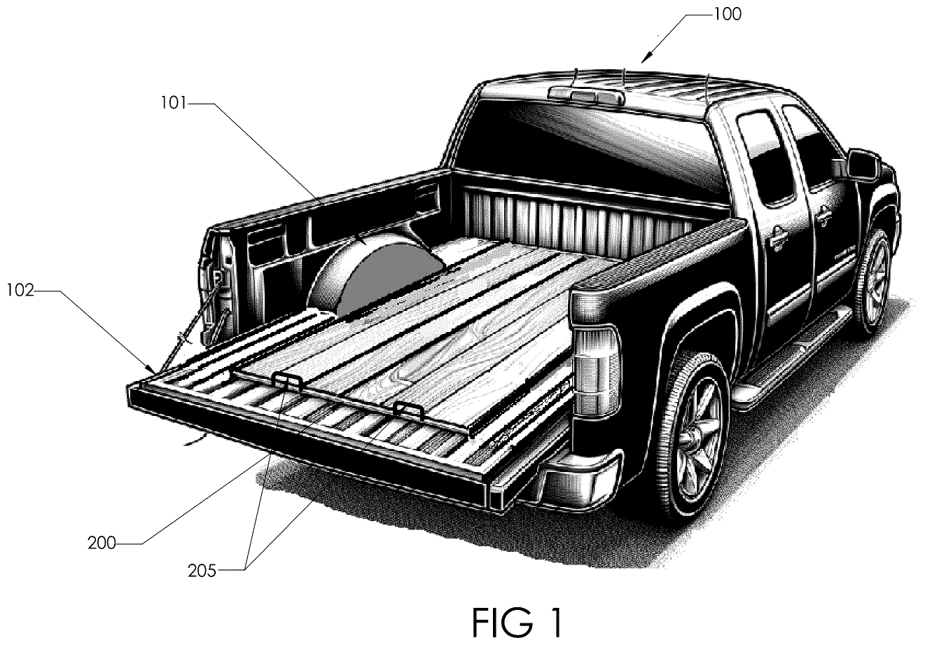

FIG. 1 shows the cargo tray 200 of the present invention placed in the bed compartment of a typical pickup truck 100 between its wheel wells 101. The tailgate 102 of the pickup truck 100 is shown pulled down with the cargo tray 200 pulled out a bit. A pair of handles 205 are attached to the front end of the tray 200 to facilitate pushing or pulling it toward or away from the front of the truck bed. The “front” being the end near the tailgate when installed. The “rear” being the end near the passenger compartment of the truck. The bed compartment of a typical pickup truck was presumably designed to accommodate 4′×8′ sheets of plywood, which are fairly standard building materials. Accordingly, the typical distance between a pickup truck's wheel wells is around 4 feet, and this limits the ideal width W of the cargo tray to about 4 feet or less. Nevertheless, different sizes cargo trays can be easily created within the scope of the present invention by changing the number of planks, their individual widths, and/or their lengths.

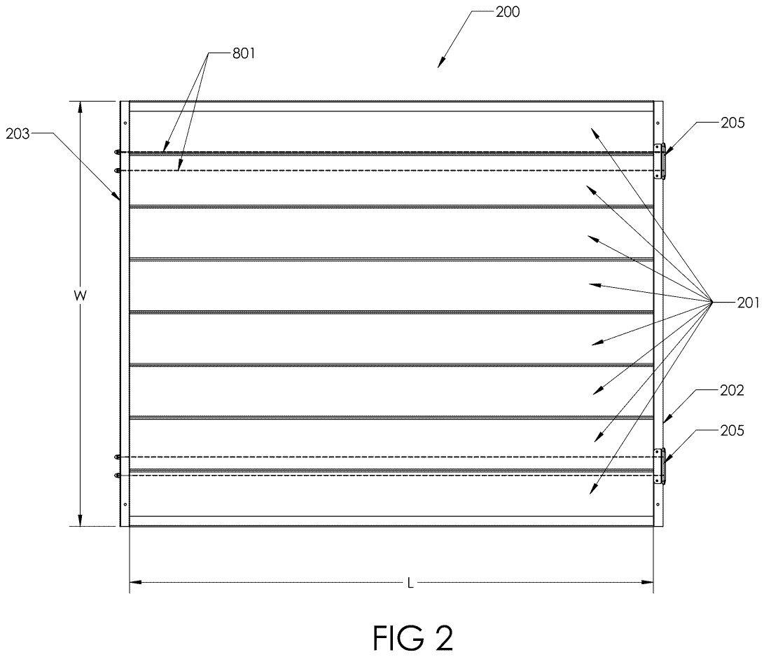

FIG. 2 is a top view of cargo tray 200, which comprises a plurality of substantially identical planks 201 that are joined together and supported at their opposite ends by a pair of support members 202, 203 that align the planks 201 into a larger flat surface i.e., a deck. A pair of identical handles 205 are attached to the front member 202 to facilitate pushing or pulling the cargo tray in and out of a truck bed or any vehicle where it is installed. Multiple tension members 801 extend between, and are attached to, the support members 202, 203 in order to support the planks as a unit when the cargo tray is pushed, pulled or carried away from the vehicle. Tension members 801 are shown as dotted lines because they reside within the planks 201, which are substantially hollow. Cargo tray 200 has a width “W” and a length “L”. Typically, the width of the cargo tray is about 4 feet and its length is about 6 feet so that it will easily fit into the bed of a pickup truck or other vehicle.

In an alternate design, tension members 801 can be avoided for ease of assembly and cost reduction by rotating the cargo tray 90 degrees and interchanging the length L and width W dimensions of the tray. However, without tension members extending parallel to the direction of pushing and pulling, the cargo tray would not be able to push or pull heavy loads into or out of a vehicle. Moreover, the handles would now attach to the plank nearest the front end of the tray, which would further weaken the ability of the tray to be pushed or pulled. Nevertheless, it might still be useful for customers who only use it for very light loads.

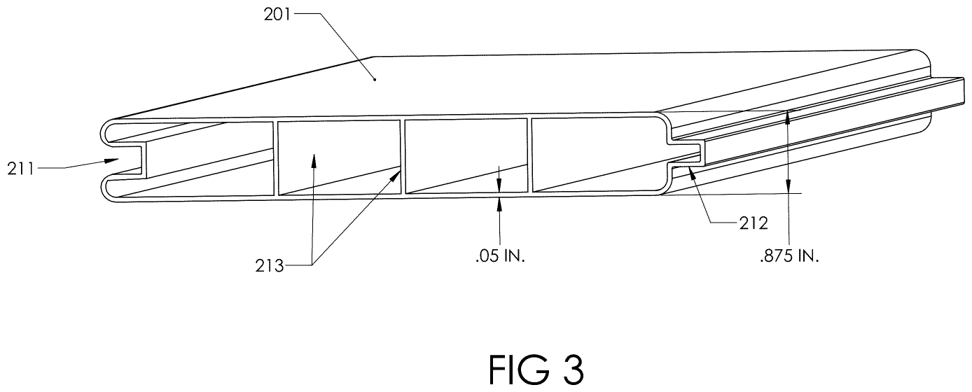

FIG. 3 is a front perspective view of one design of plank 201 with standard tongue and groove construction. Plank 201 includes a tongue 212 and a groove 211 that interconnect with adjacent planks when pushed together. Plank 201 is a hollow structure, which substantially reduces its weight and shipping cost. Vertical ribs 213 extend along the length of the plank to strengthen it and keep it from compressing when carrying cargo. Illustratively, plank 201 is made from vinyl, which further reduces its weight when compared with other materials used in known cargo tray designs. The thickness of the vinyl material used in plank 201 and its ribs 213 is about 0.050 inches and the depth of plank 201 is 0.875 inches. Dimensions are illustrative and may vary ±30% unless otherwise stated. Each plank 201 is about 6 feet long and about 7 inches wide. And because vinyl slides easily on most surfaces, including truck beds, this cargo tray does not need rollers.

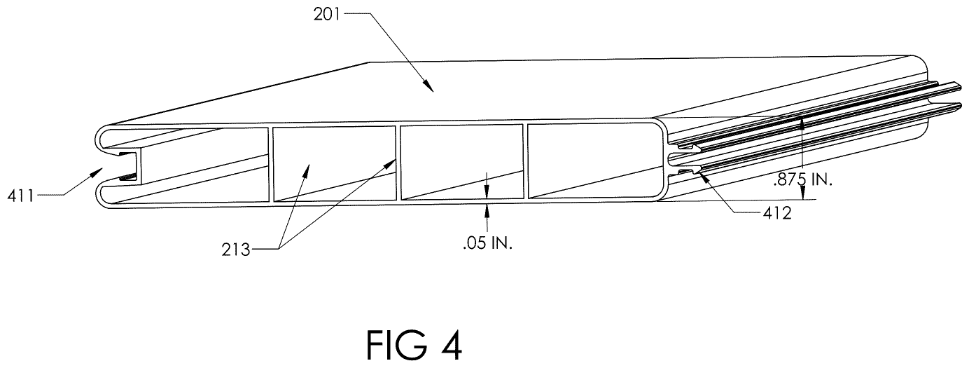

FIG. 4 is a front perspective view of an alternate design of plank 201 having interlocking tongue and groove construction, hollow structure, and vertical ribs. This plank 201 includes a tongue 412 and a groove 411 that interlock with adjacent planks when pushed together. Plank 201 is also a hollow structure that substantially reduces its weight, which reduces shipping cost and facilitates handling by the ultimate user of the cargo tray. This plank 201 also includes several vertical ribs 213 that extend along its length to strengthen it and keep it from compressing when carrying cargo.

This plank 201 is also made from vinyl, which further reduces its weight when compared with other materials used in known cargo tray designs. The thickness of the vinyl material used in plank 201 and its ribs 213 is about 0.050 inches and the depth of plank 201 is 0.875 inches. Dimensions are illustrative and may vary ±30% unless otherwise stated. This plank is substantially identical to the plank 201 shown in FIG. 3 except for its interlocking tongue and groove.

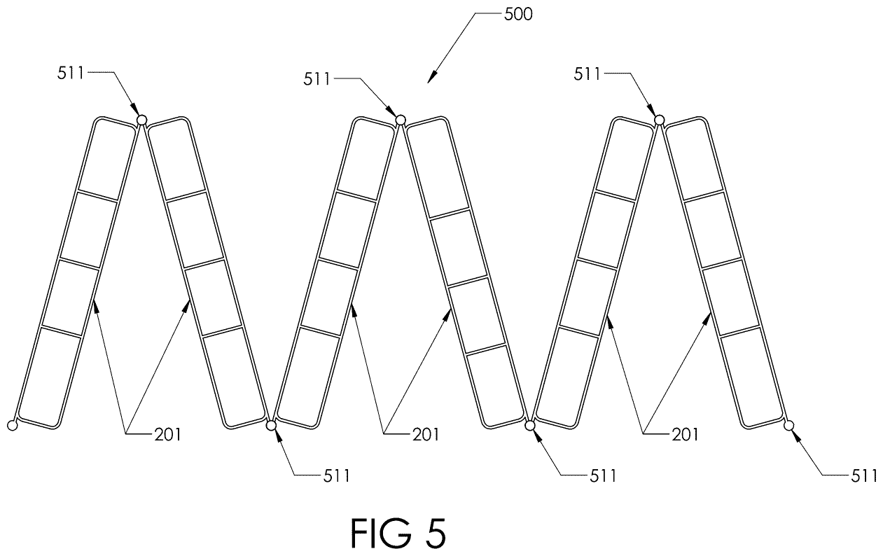

FIG. 5 is an end view of a plurality of fully connected planks 201 that are pre-joined as a unit by an integral web and can be folded into a bundle 500, which has the dimensions of the flattened cargo tray when unfolded. It demonstrates that the planks 201 do not have to be separate from each other but can be permanently joined at their junctions 511 by the same material used in forming the planks—illustratively vinyl. Such a design allows the cargo tray manufacturer to purchase a large bundle of fully connected planks and then cut them into smaller bundles for shipping to the customer. Shipping a flat 4×6 ft cargo tray is no easy matter. This design facilitates assembly into a flat cargo tray by the customer who no longer has to interconnect the planks individually. The individual planks are substantially identical to the planks shown in FIG. 3 and FIG. 4 except for the way that they are interconnected.

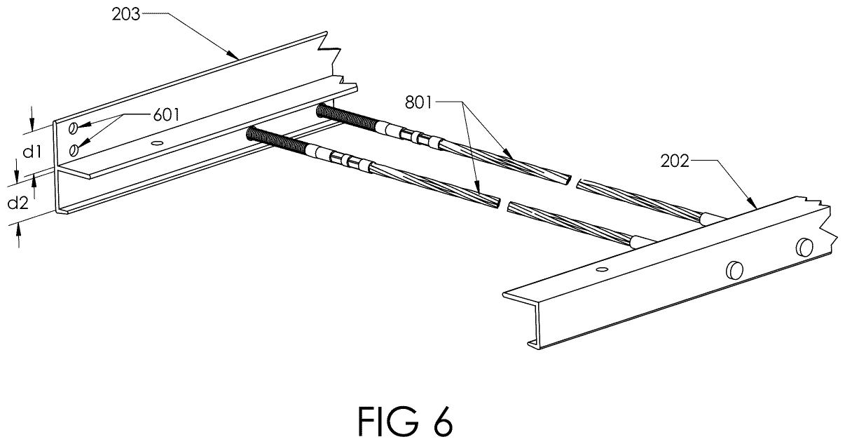

FIG. 6 is a front-side perspective view of the front and rear support members 202 and 203 that comprise extrusions-illustrative aluminum-for supporting the planks (not shown) and holding them together as a flat unit.

Tension members 801 that hold the front and rear members together are partially shown. Rear member 203 has a “T” shape, whose top side has a depth d₁ (about 3 inches). It is an upright flange that is designed to keep cargo in the tray when the tray is being pulled from the vehicle bed. The bottom side of the rear member 203 has a depth d₂ (about 0.875 inches) that corresponds to the depth of the planks. Openings 601 in the rear member 203 are used to receive a bungee cord or the like that may be connected to the back of a pickup truck to keep the cargo tray from being pulled out too far. Another pair of openings (not shown) is located at the other side of support member 203 for the same purpose.

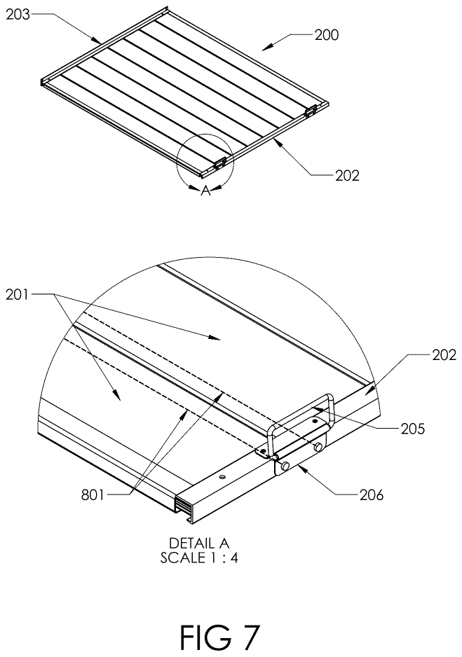

FIG. 7 is a front-side perspective view of the cargo tray 200 where Detail A shows the shape of the front member 202 that supports planks 201. One of the handles 205 is shown attached to the left end of front member 202. The other handle that attaches to the right end of front support member 202 is not shown.

Handle 205 is attached to the front member via handle frame 206 for pushing or pulling the cargo tray toward the front or back end of the vehicle and is shown rotated into an upward position. Handle frame 206 holds handle 205 and provides a mechanical stop surface that arrests handle rotation at an angle >90° relative to the tray. Having a rotation-limited handle positioned in this way gives the user more leverage when pushing the tray, and it also prevents hand placement between the handle and the tray during pushing—thereby avoiding “finger pinching”.

Finally, handle frame 206 includes two through holes that allow tension members 801 to travel through the frame. Tension members 801 are fed through openings in the panels 201, and then attached to the rear support member 203 via lock nuts or other means.

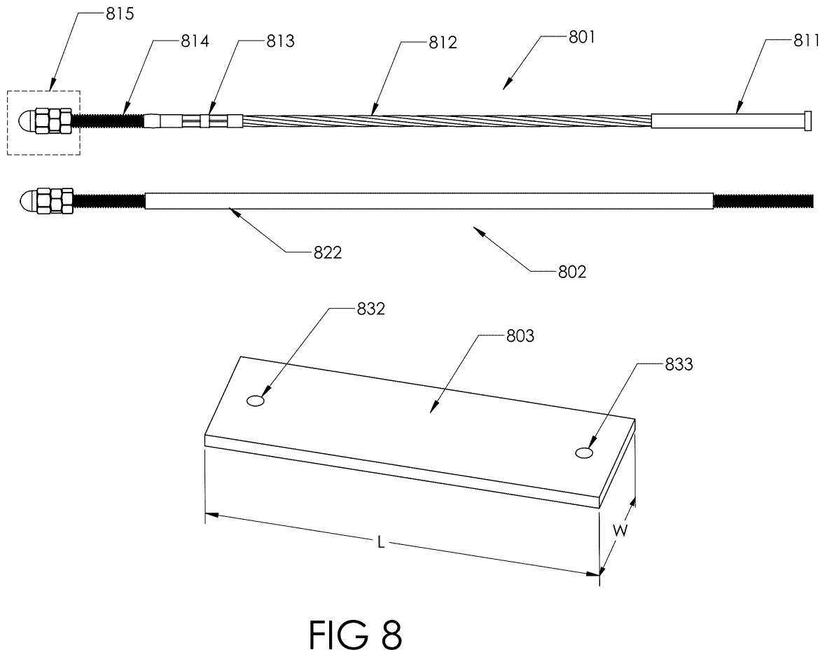

FIG. 8 shows the design of two different tension members 801, 802 that are about 6 feet in length and extend between the front and rear support members 202, 203 as shown in FIG. 6 to align the planks as a large flat surface.

Tension member 801 comprises a wire rope 812 that is connected between wire holders 811 and 813. The end section of holder 813 is coupled to a threaded rod 814, which is sized to fit through openings in the rear member 203 (see FIG. 6) and attach to lock nuts 815.

Tension member 802 is substantially identical to tension member 801 except that a cylindrical metal rod 822 replaces wire rope 812 of tension member 801, and the cylindrical metal rod 822 is threaded at both ends.

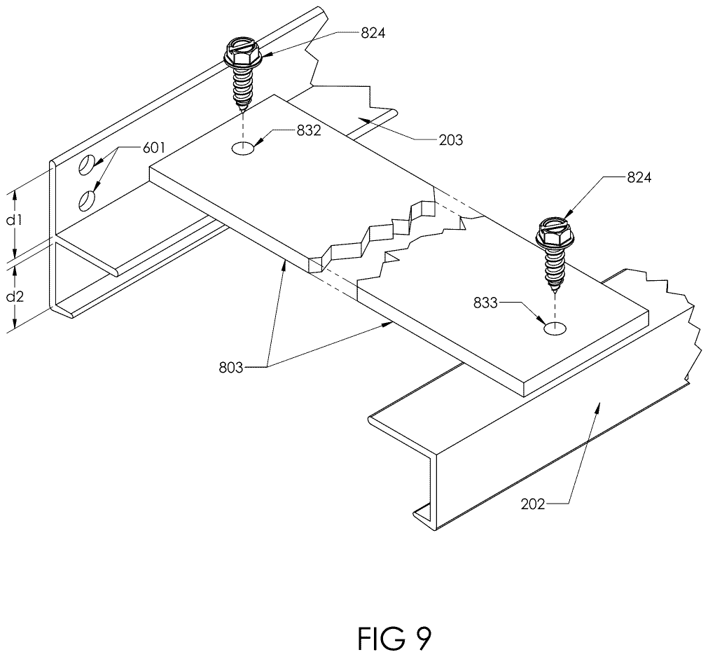

Also shown in FIG. 8 is a flat bar 802 whose length L is about 6 feet, and whose width W is about 2 inches. One or more bars can be used to replace or be used in conjunction with the tension members 801 or 802, and are attached to the front and rear support members 202, 203 as shown in FIG. 9 to align the planks into a large flat surface. And while only one hole 822, 823 is shown at each end of the metal bar, more holes may be used. Illustratively, each flat bar is an aluminum extrusion.

FIG. 9 is a front-side perspective view of front and rear support members 202 and 203 for supporting planks and holding them together as a flat unit. It shows an alternative way to hold the support members together by using several flat metal bars 803 (only one is shown) to replace the tension members 801 or 802 shown in FIG. 8. Screws 824 pass through holes 822, 823 in the metal bar and through holes in the support members in order to screw into the planks (not shown) and secure each metal bar in place.

Rear member 203 has a “T” shape, whose top side has a depth d₁ (about 3 inches). It is a backstop that is sized to keep cargo in the tray when the tray is being pulled from the vehicle bed. The bottom side of the rear member 203 has a depth d₂ (about 0.875 inches) that corresponds to the depth of the planks.

Finally, openings 601 in rear member 203 are used to receive a bungee cord or the like that can be connected to the back of a pickup truck to keep the cargo tray from being pulled out too far. Another pair of openings (not shown) is located at the other side of support member 203 for the same purpose.

1. A cargo tray for a vehicle cargo bed comprising:
a deck formed by a plurality of elongate planks, each having length and width, that are interconnected side-by-side along their lengths and held together as a unit to form a flat surface;
a pair of support members that are attached transverse to the plank lengths to hold them together as a flat unit, one at each end of the planks; and
one or more handles that are mounted at the front end of the deck for pushing or pulling the cargo tray toward the front or back end of a vehicle.

2. The cargo tray of claim 1 further including a plurality of tension members that extend between the support members and are configured, when tightened, to draw the support members toward one another and place the planks in longitudinal compression so that the deck behaves as a flat unit, wherein the tension members comprise wire-ropes or metal rods having threaded end fittings that are tightened by lock nuts; and
a handle assembly comprising the handle and a frame, which holds the handle and allows it to rotate, is mounted on the support member at the front end of the cargo tray for pushing or pulling the tray toward the front or back end of the vehicle.

3. The cargo tray of claim 2 wherein the handle assembly is rotation-limited to improve pushing leverage and avoid finger pinching.

4. The cargo tray of claim 2 wherein the support member that is located at the rear end of the tray includes an upright flange for keeping cargo in the tray when the tray is being pulled from the vehicle.

5. The cargo tray of claim 2 wherein the planks have low friction on at least one side to facilitate sliding along the bed.

6. The cargo tray of claim 2 wherein the planks comprise vinyl.

7. The cargo tray of claim 6 wherein the planks are hollow with a plurality of vertical ribs.

8. The cargo tray of claim 2 wherein the planks have equal length and are equal to one another in width.

9. The cargo tray of claim 2 wherein each plank has a tongue along one side of its length and a groove along the other side of its length for supporting the planks together.

10. The cargo tray of claim 9 wherein the tongues and grooves are shaped to interlock together.

11. The cargo tray of claim 2 wherein the planks are pre-joined as a unit by an integral web and can be folded into a bundle, which has the dimensions of the flattened cargo tray when unfolded.

12. A cargo tray for a vehicle cargo bed comprising:
a deck formed by a plurality of elongate planks arranged side-by-side and interconnected along their lengths;
lengths at opposite ends of the deck to form the planks into a flat surface;
flat bars spanning between the support members and connected thereto to hold the support members and the planks together as a single unit; and
on the front support member for pushing or pulling the cargo tray toward the front or back end of the vehicle.

13. The cargo tray of claim 12 wherein each flat bar has one or more holes at its opposite ends aligned with corresponding holes in the support members, and screws connected through these holes and into the planks.

14. The cargo tray of claim 12 wherein the handle assembly is rotation-limited to improve pushing leverage and reduce pinching.

15. The cargo tray of claim 12 wherein the planks have low friction on at least one side to facilitate sliding along the vehicle cargo bed.

16. The cargo tray of claim 15 wherein the planks comprise vinyl.

17. The cargo tray of claim 16 wherein each plank is hollow and has a plurality of vertical ribs.

18. A method of assembling a cargo tray comprising:
positioning a plurality of equal-length planks together, side-by-side, along their lengths to form a deck;
placing support members at the front and back ends of the deck, each support member being transverse to the length of the planks and being substantially straight;
routing tension members having threaded ends between the support members and tightening the threaded ends with lock nuts to compress the planks longitudinally;
and
mounting a handle to the front support member for pushing or pulling the deck.

19. A method for assembling a cargo tray comprising:
positioning a plurality of equal-length planks together, side-by-side, along their lengths to form a deck;
placing support members at the front and back ends of the deck, each support member being transverse to the length of the planks and being substantially straight;
laying flat bars across the deck, one end of each flat bar being attached to one of the support members and the other end of each flat bar being attached to the other support member; and
mounting a handle to the front support member for pushing or pulling the deck.
